(19) United States
(12) Patent Application Publication
(10) Pub. No.: US 2005/0104872 A1
(43) Pub. Date: May 19, 2005

(54) Input device and method for inputting information into a control unit

(75) Inventor: Dieter Geiger, Kelheim (DE)

Correspondence Address: JOHN T. WINBURN, 100 BOSCH BOULEVARD, NEW BERN, NC, 28562, US

(73) Assignee: BSH Bosch und Siemens Hausgerate GmbH, Munich (DE)

(21) Appl. No.: 11/020,884

(22) Filed: Dec. 22, 2004

(30) Foreign Application Priority Data
Jul. 31, 2002 (DE) 102 34 922.3
Jul. 23, 2003 (WO) PCT/EP03/08054

(51) Int. Cl. G09G 5/00

(52) U.S. Cl. 345/179

(57) ABSTRACT

An input device for inputting control information and/or settings into a central control unit of a household appliance. The input device is designed for external input and/or output of signals and/or inner states of the household appliance control device.

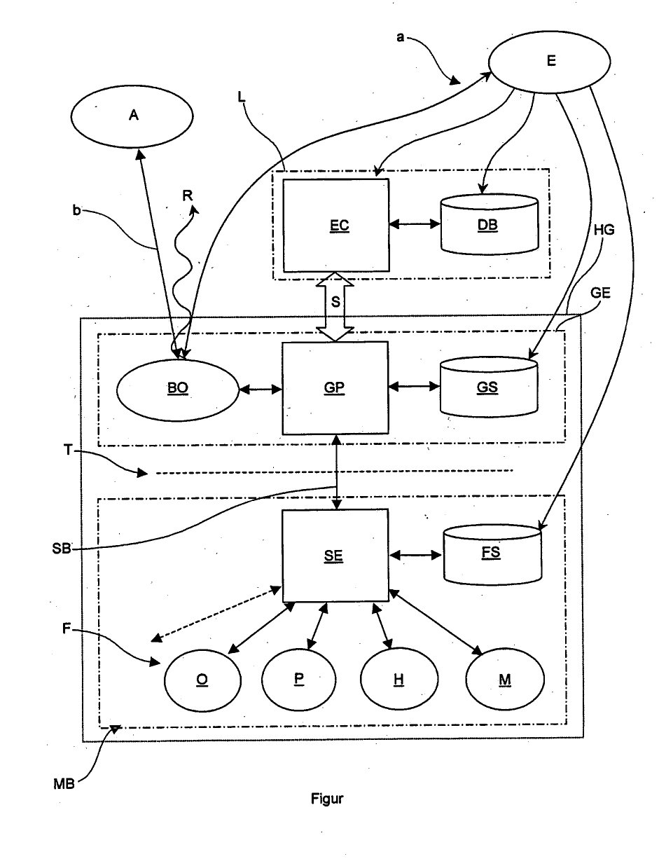

The invention relates to an input device for inputting information into a control unit, especially a device for inputting a setting and/or control information into a central control unit of a household appliance. The invention further relates to a household appliance, a method for inputting information and for creating an input device and a computer program product.

Devices and corresponding methods are known in which an input device is executed in the form of a user interface with a switch, buttons, rotary switches etc. and corresponding lettering. Access of a user to a household appliance or an application of a function of a respective household appliance is specified anew for each model. Control information has to be input via a respective input device in a rigidly pre-determined manner. As a result, the development of such household appliances, and also their use, application and operation by a user is made difficult. Use of user interfaces with a display panel or display in the form of liquid crystal displays and associated input elements makes no substantial difference to this situation.

It is the object of the present invention to create an improved device with regard to the mechanism and form thereof, a correspondingly equipped household appliance and a corresponding method, wherein a method according to the invention is also to be represented as a computer program product and should be able to be used on a computer.

The object is solved according to the invention by a device having the features of claim 1, a household appliance having the features of claim 8 and a method having the features of claim 11. Furthermore, a computer program product according to claim 14 is also a solution of the preceding object. Advantageous further developments of the invention are the subject matter of the respective dependent claims.

According to the invention, an input device for inputting information into a control unit, especially a device for inputting control information and/or settings into a central control unit of a household appliance, wherein the device has a user interface comprising a display and input elements, is characterised in that the input device comprises a device which is constructed for external input and/or output of signals and/or inner states of the control unit. Thus, in every state in the running process of a household appliance, intervention can be made from outside wherein the signals can be further processed in a freely selected fashion, preferably outside the household appliance. Various types of preparation and post-processing are then specified subsequently with reference to an exemplary embodiment of the invention.

As a result of the structure according to the invention, completely new possibilities are provided in the development, during a test phase and also in operation on site at the end users, especially using a display or a display panel and an associated input element.

In an important further development of the invention, the device is executed as a standardised interface. The term interface is understood both as a physical object and also as a type of pick-up for signals or program structures. Consequently, connection of an input device according to the invention is only required when necessary, i.e., to reduce the cost of the household appliance, the input device according to the invention can be executed separately in an adapted form. In this case, in a preferred embodiment the device used for communication is constructed as a serial interface. A serial interface is a relatively commonly used interface in computer and measurement technology by which means a sufficiently high data transfer rate can be ensured with moderately high data security even in an electro-magnetically loaded environment, such as especially during manufacture or in a test stand. At the same time however, actuation or input is still possible via the control panel. However, this form of data input is restricted with regard to its scope and its possibilities.

The input device is preferably connected to an external service computer for extended programming via the device for inputting and/or outputting signals of the control unit. The performance of modern computers with their now largely fully developed scope for displaying graphically prepared user interfaces is sufficient for a purpose according to the invention. Accordingly, a computer program product according to the invention is advantageously constructed so that it can be run under a widely used operating system for personal computers or PCs or minicomputers, especially computers according to the IBM standard. A laptop is preferably used as a minicomputer. A Windows operating system from the Microsoft company, such as for example, Windows 95, Windows NT version 4.0 or a higher follow-up version in each case, is especially provided as the operating system. Usage of such operating systems with their software structures which are already standard in many cases increases the general acceptance and the readiness for use of a device according to the invention as a versatile tool. Furthermore, the general appearance of a user interface and the operation are known. Thus, already prepared measures of the standardised infrastructure of the operating systems can also be used by a computer program product according to the present invention, for example, a keyword-oriented or context-guided help function. The help function is preferably constructed as situation-related, i.e., on calling up the help function, detailed help based on a representation of an actual screen display is offered which can then be selected for example by clicking on a complex on the screen etc.

In one embodiment of the invention, a library and/or a database containing functions and graphical elements is provided in the input device. The content can in turn be changed via an interface according to the invention. The elements of the database can be used to build up and/or to configure a user interface on the household appliance itself and also to configure an external monitoring, input and user interface on the input device. Scales, lettering, menu forms and sequences of submenus can thus be defined and adapted to an application. In particular, an end user of a household appliance according to the invention is provided with a possibility for direct and individual adaptation of a user and control interface.

A memory for saving the configuration and function is preferably provided in the input device and/or on the central control unit of the household appliance. Thus, tried and tested settings can be preserved in a simple and reliable fashion. In this case, only a certain selection of functions, symbols, displays and their links and respective arrangement is taken over, so that the memory space to be provided need only have a relatively small size as an especially non-volatile memory.

In a preferred embodiment of the invention the operating interface has at least one form of feedback for a user. The feedback or acknowledgement in positive or negative form is made especially for a command input in a tactile, acoustic and/or optical form. In this case, the signals are preferably uniquely associated with a respective function, button position or a menu etc. Through the type of feedback, the operation of an input or a check on its correctness can quickly be learnt by a user.

Advantageously a household appliance has an input device according to one or more of the features described previously wherein the household appliance is divided into a control section and a performance section. The performance section is thus provided largely independently of the control section and its programming centrally in the respective household appliance, whereby the control section conversely can be built up and constructed independently of the appliance. Thus, respectively one converter for control commands output by a central control unit is provided in the performance section of the household appliance. In this case, the central control unit is adapted to the converter such that the level required by a function section inside the household appliance is always achieved and signal forms output. Thus, the entire command input and/or preparation and control of a user interface is advantageously separate from this purely equipment technology side which as a structural feature allows a computer program product according to the invention to be used without any problems for all types of household appliances, making full use of the possibilities and advantages described previously. Consequently, household appliances of many different types, such as for example a cooker with oven, grill and microwave, a laundry treatment machine, a dishwasher, a refrigerator et can be tested, set up and/or operated in a similar fashion.

Furthermore, an interface of an input device according to the invention can also be constructed for parallel operation of a plurality, preferably of up to eight household appliances. With this further development of a method according to the invention, for example long-term testing and parallel-running evaluation work can then be carried out very conveniently.

Thus, a universally applicable user program has been presented hereinbefore which can be used not only for one type of household appliance but for all household appliances which have a standardised interface. This interface can be uniformly defined according to an internal standard and be designed for service interventions by a customer service and/or intervention by a user. The device communicates with the respective household appliance via the interface in order to read in and/or read out memory contents, to prepare internal states in a variously pre-determined fashion and also to indicate. Furthermore, the memory contents can be freely varied or re-written and stored externally. Thus, a new tool is provided for the design of an individual user interface on a household appliance. In addition, a device according to the invention using a corresponding program product makes it possible to create and/or subsequently amend or adapt a user interface with which a respective device can be quickly learnt and operated, programmed or controlled as intuitively as possible. It is also possible for the user as the end customer to create their own display by subsequent amendment within pre-determined limits which are pre-defined for safety reasons by the manufacturer of the household appliance, which in one embodiment of the invention is also carried out in a user-guided fashion. In this case, use is made of database elements and default formats so that a selection, adaptation, arrangement and/or link is made in a simple fashion especially via input elements, such as, for example, pointer, mouse, keypad, touchpad or touchscreen. It is thus easily possible to adapt design, arrangement and also a function according to one's own taste and also development work of control systems of any household appliances and their testing.

An exemplary embodiment of the invention is explained in detail subsequently with reference to the drawing whilst specifying further advantages.

In the drawing the only figure shows a schematic diagram of an input device according to the invention. Shown as larger blocks are a portable minicomputer or a laptop L and a household appliance HG which, in an application a, are interconnected under monitoring by a developer or customer service worker E via an interface S. Via the interface S data are transferred from the laptop L into the household appliance HG. In the present case, this primarily involves data and program sections for constructing and for representing a graphical user interface BO on the household appliance HG which is built up in a control section characterised separately in the drawing as a box with dashed lines or graphics unit GE using a graphics processor GP from a graphics memory GS.

The graphical user interface BO comprises a graphics screen or a graphics LCD not shown in further detail in the form of a central indicating and control section. The user interface also has interactive control or command input by means of a touch-controlled graphics surface or a touchscreen. Alternative or additional control elements in the form of a switch, button or rotary knob can also be provided, these being then arranged close to or even enclosed by the contact-controlled graphics surface so that they can be lettered depending on a respective context for more complex program steps. Thus, complete and fixed lettering is no longer provided. Adaptations to various languages can thus be carried out very simply. In addition, the user interface BO is constructed to output feedback signals R which are output here at the same time as optical, acoustic and tactile signals: a selected setting or function changes its colour whilst flashing, an acknowledgement tone sounds and in addition, the actuated control element vibrates in contact with the finger of a person making the input at a highly perceptible frequency. Even under adverse circumstances, notice is thus taken of a positive or negative acknowledgement as a conclusion or confirmation of an input action.

In the present exemplary embodiment, the incoming and outgoing signals of the user interface BO are received centrally by the graphics processor GP and from there possibly passed on to a central control unit SE. These elements form the control section which is also standardised with regard to its physical structure. Arranged between the graphics processor GP and the central control unit SE there is thus a structural and also logical dividing plane T between the control section and a performance section. Here the transition is made from a substantially software-based signal processing to a reforming and preparation matched to the respective hardware, as control commands SB for various drivers for adaptation to a respective electrically driven or controlled function element F in a machine area MB. Shown here merely as examples of function elements F for a household appliance HG in the form of a laundry treatment appliance are an electrically driven and electronically controlled normally closed contact 0, a pump P, a heater H and a motor M. In this case, various sensors and/or emergency switches which are also connected via signal leads to the control unit SE, can be added to each of the function elements F in a known fashion. Thus, the signal paths indicated between the respective function elements F and the central control unit SE are always constructed as double arrows.

In addition, the control unit SE is connected to a non-volatile memory or a read-only memory FS in which programs and routines for the control unit SE are saved. Via the interface S, in the application case a, a customer service employee E can introduce a renewal and/or extension of machine operation programs into the read-only memory FS, commonly in technical usage also called a firmware update. Since at this point, protocols for long-term and/or short-term error analysis are also written to the read-only memory FS, it is also very useful to read out the read-only memory FS in the development and maintenance of the household appliance. The protocols within the read-only memory FS are retained in any case as operation history but can also be overwritten or partly deleted by the customer service employee E via the interface S.

Connected via the interface S is a laptop L specially equipped with diagnosis tools and preparation and evaluation programs in order to test a newly developed household appliance HG and finally in order to be able to analyse behaviour in a simulated case of error which has actually been brought about. Thus, this additional function need not be executed separately in each household appliance HG. Rather, it is available as required via the interface S in an adapted fashion at low expenditure. A selection of the respective programs is made individually depending on the respectively present household appliance.

Use in the development of a household appliance HG and during its maintenance or repair has primarily been described hereinbefore. However, the advantage of the household appliance HG for the end customer in daily use should be considered separately, application case b. In this case, the end customer or user A can make individual adaptations and changes to form, structure and content of menus of the graphical user interface BO via the household appliance HG itself. Thus, the entire operation and handling of the household appliance HG is no longer rigidly specified. Rather it can be widely adapted in form, configuration features, content and scope by the user A.

Using the input device according to the invention, it is also possible to create so-called macro-documents as templates which contain a plurality of series of commands. The macro-documents are backed up and can be retrieved again at any time. The following commands are possible as macro-commands:
Wait Implements a waiting time in milliseconds
Repeat Implements a loop of repetitions
End Repeat Marks the end of the repeat loop
Send security
code Sends the security code so that writing access is released
Write memory Writes the specified value into the specified address
Write variable Writes the specified value to the address of the specified variables
Amend value Makes it possible to amend a memory line
Read memory Reads out the specified value and displays this

1-17. (canceled)

18. An input device for inputting control information and/or settings into a central control unit of a household appliance, comprising:
a central control unit;
the input device including a user interface including a display and input elements; and
said input device designed for external input and/or output of signals and/or inner states of said control unit.

19. The input device according to claim 18, including said input device is executed as a standardized interface.

20. The input device according to claim 18, including said input device is constructed as a serial interface.

21. The input device according to claim 18, including said input device is coupled to an external service computer for extended programming via said user interface.

22. The input device according to claim 18, wherein said input device includes a library and/or database with functions and graphic elements for configuring a user interface on the household appliance and/or for configuring an external user interface.

23. The input device according to claim 18, including a memory for saving a configuration and function is provided in said user interface and/or in the central control unit of the household appliance.

24. The input device according to claim 18, including the household appliance is constructed to output at least one form of feedback signal to a user in the form of at least one of a tactile, acoustic and/or optical feedback or acknowledgement, each of said feedback signals are uniquely associated with a one of at least a button position, a function or a menu.

25. The input device according to claim 18, including the appliance including said input device.

26. The input device according to claim 25, wherein said input device is separated into one of a control section or a graphics unit and one of a performance section or a motor area.

27. The input device according to claim 25, including said input device has an interactive control graphics screen.

28. The input device according to claim 27, including said interactive control graphics screen is an LCD touchscreen.

29. A method for creating an input device, comprising:
constructing a user interface as an outer element of a control section using a graphics processor from elements of a graphics memory.

30. The method according to claim 29, including providing access to said graphics processor and/or said graphics memory via an interface for a developer and/or a customer service employee.

31. The method according to claim 29, including providing an interactive operation for said graphics processor by a graphics screen or a graphics LCD screen which returns selections signals as a touchscreen.

32. A computer program product, comprising:
a computer-readable storage medium on which a program is saved;
a memory into which said computer-readable storage medium is loaded; and
said loaded computer-readable storage medium is readable by a computer device to read, write and/or modify internal states of a central control system of a household appliance to configure a user interface.

33. The computer program product according to claim 32, including said computer-readable storage medium including a help function operated on a keyword-oriented, context-guided and/or situation-related basis.

34. The computer program product according to claim 32, including said computer-readable storage medium constructed to run under a conventional personal computer operating system.
